(19) United States
(12) Patent Application Publication
(10) Pub. No.: US 2023/0232260 A1
(43) Pub. Date: Jul. 20, 2023

(54) RESOURCE CONFIGURATION FOR RECIPROCAL CROSS-LINK INTERFERENCE MEASUREMENT

(71) Applicant: QUALCOMM Incorporated, San Diego, CA (US)

(72) Inventors: Yuwei REN, Beijing (CN); Huilin XU, Temecula, CA (US)

(21) Appl. No.: 18/002,597

(22) PCT Filed: Aug. 3, 2020
(86) PCT No.: PCT/CN2020/106514

§ 371 Date: Dec. 20, 2022

(51) Int. Cl. H04W 24/08; H04W 24/10; H04W 72/541

(52) U.S. Cl. CPC H04W 24/08; H04W 24/10; H04W 72/541

(57) ABSTRACT

Aspects of the present disclosure relate to wireless communications, and more particularly, to techniques for configuring cross link interference (CLI) measurement resources for potential aggressor UEs. An example method generally includes receiving, from a network entity, configuration information identifying a cross link interference (CLI) resource; measuring interference with respect to one or more other UEs on the identified CLI resource; and transmitting, to the network entity, a measurement report based on the measured interference.

### TECHNICAL FIELD

Aspects of the present disclosure relate to wireless communications, and more particularly, to techniques for configuring resources for measuring cross-link interference (CLI) in wireless communications systems.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (for example, bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (for example, 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several innovative aspects, no single one of which is solely responsible for the desirable attributes.

One innovative aspect of the subject matter described in this disclosure can be implemented in a method for wireless communication by a user equipment (UE). The method generally includes receiving, from a network entity, configuration information identifying a cross link interference (CLI) resource, measuring interference with respect to one or more other UEs on the identified CLI resource, and transmitting, to the network entity, a measurement report based on the measured interference.

One innovative aspect of the subject matter described in this disclosure can be implemented in a method for wireless communication by a network entity. The method generally includes transmitting, to a user equipment (UE), configuration information identifying a cross link interference (CLI) resource, receiving, from the UE, a measurement report including one or more measurements of interference with respect to one or more other UEs on the identified CLI resource, and taking one or more actions to mitigate potential interference to the UE based on the received measurement report.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail some illustrative features of the one or more aspects. These features are indicative, however, of but a few of the various ways in which the principles of various aspects may be employed.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows an example wireless communication network in which some aspects of the present disclosure may be performed.

FIG. 2 shows a block diagram illustrating an example base station (BS) and an example user equipment (UE) in accordance with some aspects of the present disclosure.

FIG. 3A illustrates an example of a frame format for a telecommunication system.

FIG. 3B illustrates how different synchronization signal blocks (SSBs) may be sent using different beams.

FIG. 4 illustrates examples of cross link interference between different UEs, in accordance with some aspects of the present disclosure.

FIG. 5 illustrates an example scenario in which cross link interference exists between UEs in different cells.

FIG. 6 illustrates an example scenario in which cross link interference exists between UEs in a same cell.

FIG. 7 illustrates example operations for wireless communication by a user equipment (UE), in accordance with some aspects of the present disclosure.

FIG. 8 illustrates example operations for wireless communication by a network entity, in accordance with some aspects of the present disclosure.

FIG. 9 is a message flow diagram illustrating example messages exchanged between a UE and a network entity to configure cross link interference measurement, in accordance with some aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to mobility techniques that allow for the configuration of resources for measuring cross-link interference (CLI) in wireless communications systems.

The following description provides examples of configuring resources for measuring cross-link interference (CLI) in wireless communications systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

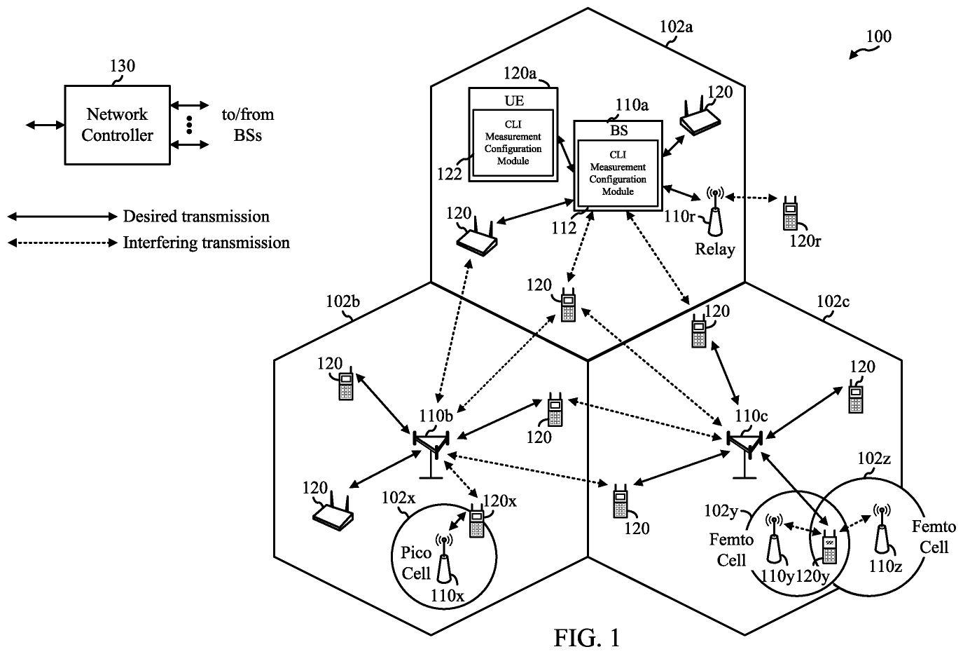

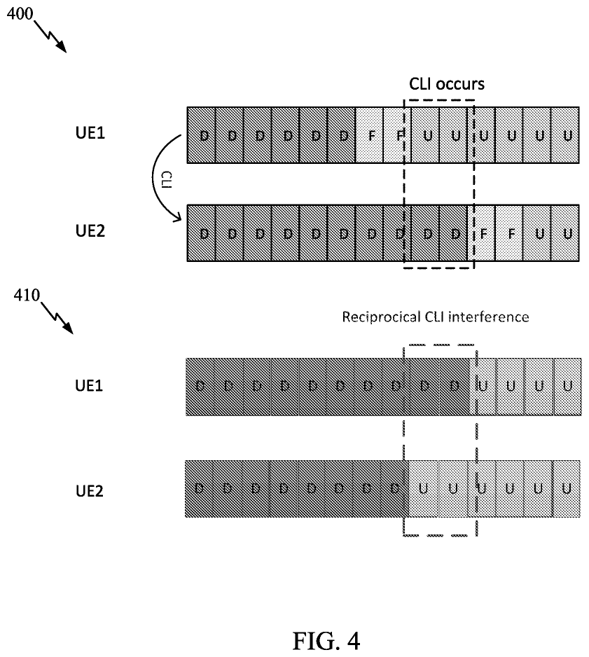

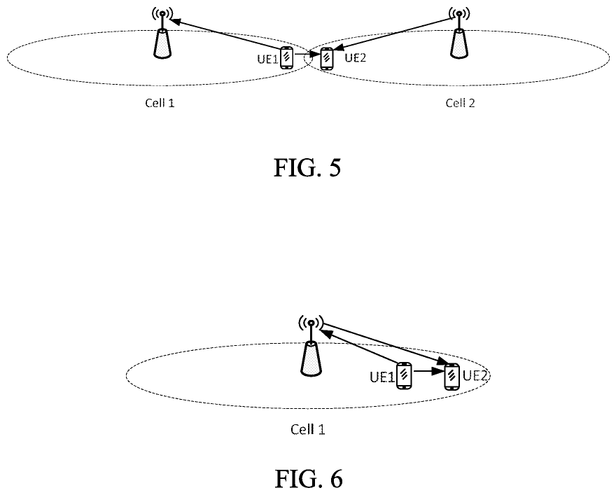

FIG. 1 illustrates an example wireless communication network 100 in which aspects of the present disclosure may be performed. For example, as shown in FIG. 1, UE 120a may include a CSI measurement configuration module 122 that may be configured to perform (or cause UE 120a to perform) operations 500 of FIG. 5. Similarly, a BS 120a may include a CSI measurement configuration module 112 that may be configured to perform (or cause BS 110a to perform) operations 600 of FIG. 6.

NR access (for example, 5G NR) may support various wireless communication services, such as enhanced mobile broadband (eMBB) targeting wide bandwidth (for example, 80 MHz or beyond), millimeter wave (mmWave) targeting high carrier frequency (for example, 25 GHz or beyond), massive machine type communications MTC (mMTC) targeting non-backward compatible MTC techniques, or mission critical services targeting ultra-reliable low-latency communications (URLLC). These services may include latency and reliability requirements. These services may also have different transmission time intervals (TTI) to meet respective quality of service (QoS) requirements. In addition, these services may co-exist in the same time-domain resource (for example, a slot or subframe) or frequency-domain resource (for example, component carrier).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another or to one or more other BSs or network nodes (not shown) in wireless communication network 100 through various types of backhaul interfaces (for example, a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (for example, 120x, 120y, etc.) may be dispersed throughout the wireless communication network 100, and each UE 120 may be stationary or mobile.

Wireless communication network 100 may also include relay stations (for example, relay station 110r), also referred to as relays or the like, that receive a transmission of data or other information from an upstream station (for example, a BS 110a or a UE 120r) and sends a transmission of the data or other information to a downstream station (for example, a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (for example, directly or indirectly) via wireless or wireline backhaul.

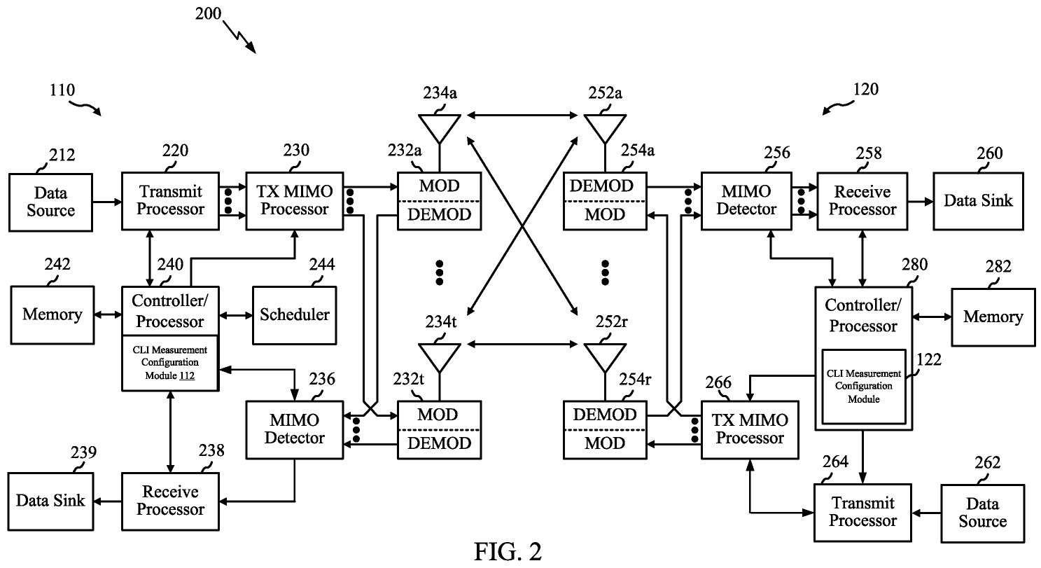

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

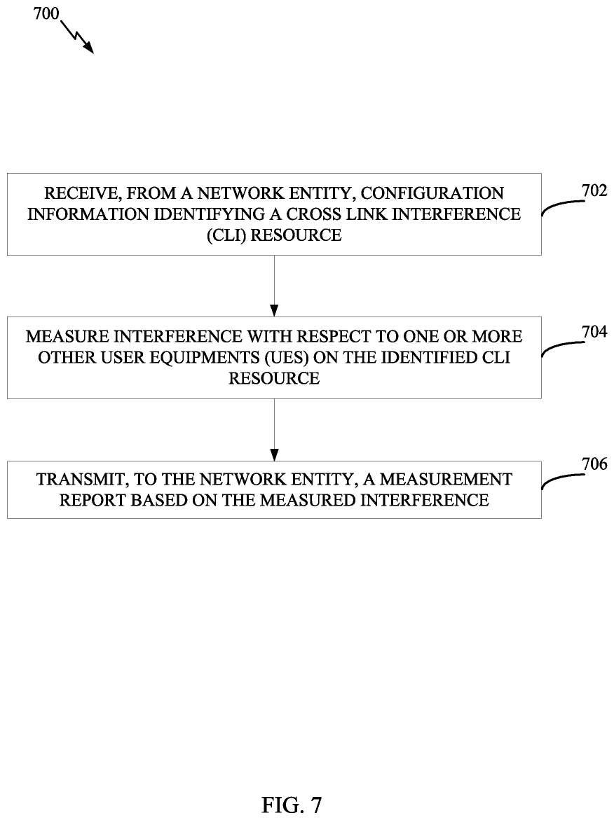

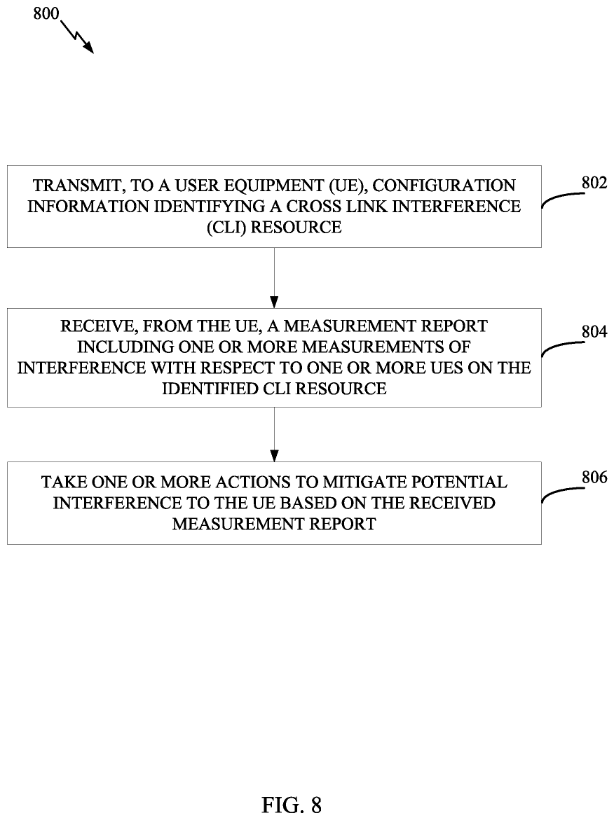

The controller/processor 280 or other processors and modules at the UE 120 may perform or direct the execution of processes for the techniques described herein. As shown in FIG. 2, the controller/processor 280 of the UE 120 has a CLI measurement configuration module 122 that may be configured to perform (or cause UE 120 to perform) operations 700 of FIG. 7. Similarly, the BS 120a may include a CLI measurement configuration module 112 that may be configured to perform (or cause BS 110a to perform) operations 800 of FIG. 8.

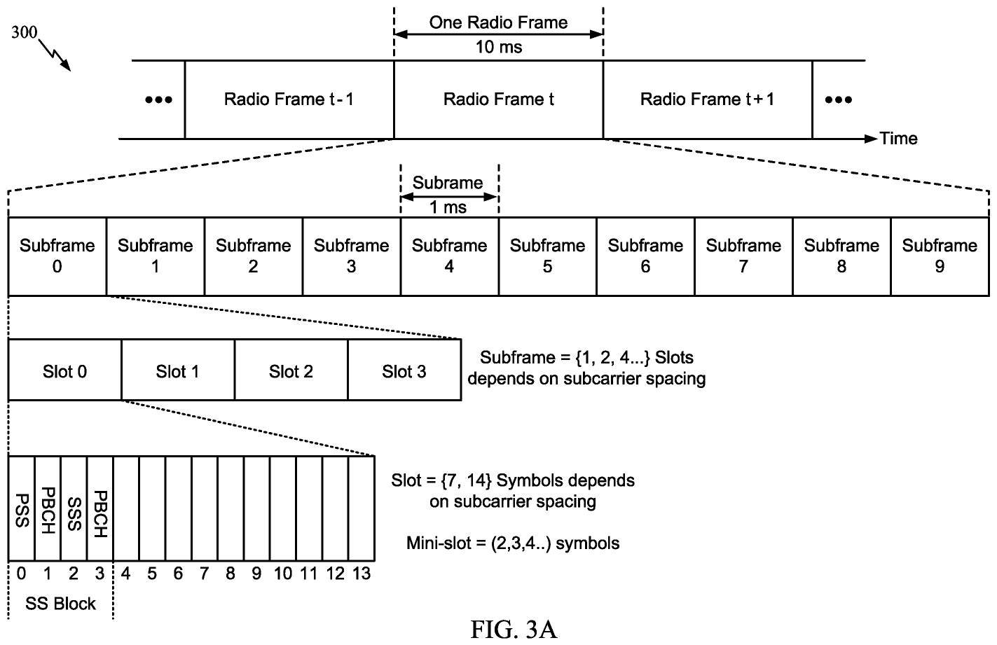

FIG. 3A is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3A. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

As shown in FIG. 3B, the SS blocks may be organized into SS burst sets to support beam sweeping. As shown, each SSB within a burst set may be transmitted using a different beam, which may help a UE quickly acquire both transmit (Tx) and receive (Rx) beams (particular for mmW applications). A physical cell identity (PCI) may still decoded from the PSS and SSS of the SSB.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE. According to aspects of the present disclosure, a CORESET is a set of time and frequency domain resources, defined in units of resource element groups (REGs). Each REG may comprise a fixed number (e.g., twelve) tones in one symbol period (e.g., a symbol period of a slot), where one tone in one symbol period is referred to as a resource element (RE). A fixed number of REGs may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE, and the UE may receive the NR-PDCCH by searching in search spaces for the UE and decoding the NR-PDCCH transmitted by the NodeB.

### Example Methods for Configuring Cross Link Interference (CLI) Measurement Resources for Measuring Reciprocal CLI

Aspects of the present disclosure relate to wireless communications, and more particularly, to configuring resources for measuring cross-link interference (CLI) in wireless communications systems. As will be described in greater detail below, resources may be configured to measure CLI between different UEs and report CLI to a network entity to allow for adjustments to be made to communication parameters based on the measured CLI to mitigate CLI between the different UEs.

Cross link interference generally exists in a wireless communication system as UE-to-UE interference, where one UE is an aggressor (e.g., causes interference) and another UE is a victim (e.g., receives interference). CLI may exist in time domain duplex (TDD) systems, where UEs in close proximity to each other have different uplink/downlink slot formats. CLI may be caused by uplink transmissions from the aggressor UE, including the UE transmitting a physical uplink control channel (PUCCH), physical uplink shared channel (PUSCH), a physical random access resource channel (PRACH) preamble, a sounding reference signal (SRS), or the like, on uplink symbols that overlap with downlink symbols for another UE.

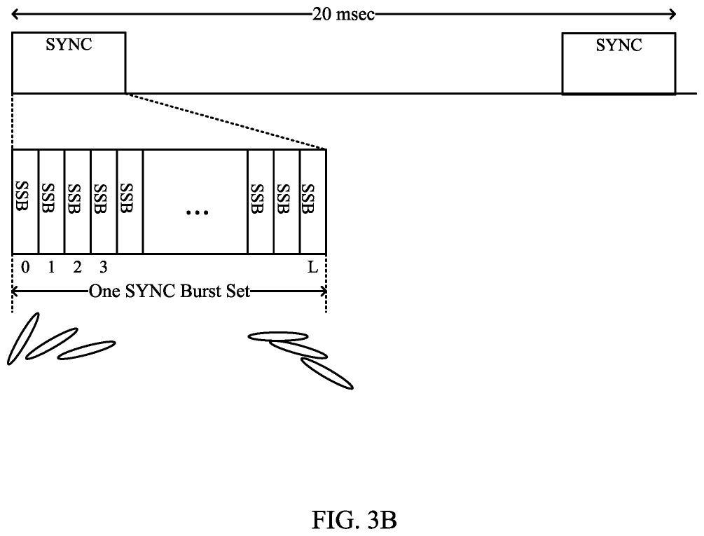

FIG. 4 illustrates an example of CLI between two UEs. As illustrated in example 400, CLI may occur when the two uplink symbols scheduled for UE 1 overlap with downlink symbols for UE2. Generally, because of the reciprocal properties of a channel between wireless communication devices, interference caused by UE 1 to UE 2 may have similar properties to interference caused by UE 2 to UE 1. Thus, the interference illustrated in example 400 may be reciprocal to the interference illustrated in example 410, where uplink symbols scheduled for UE 2 overlap with downlink symbols for UE 1.

Generally, to measure CLI, a network entity can configure CLI resources, and a victim UE can measure interference on the CLI resources for interference measurement. The measurement may be, for example, a sounding reference signal (SRS) reference signal received power (RSSI) (SRS-RSSI), a CLI RSSI, or other interference measurements. Measurements based on an SRS may be based on SRSs transmitted by an aggressor UE, while RSSI can be measured based on any uplink transmission from the aggressor UE. The measurement resource configuration may be provided in measurement objects and may include information identifying the resources that a victim UE can use to measure CLI, such as the periodicity of CLI resources, frequency resource blocks (RBs) and OFDM symbols where CLI is to be measured, and the like.

Generally, to handle cross link interference, a victim UE may report, to a network entity, that a CLI scenario exists. In response, the network entity can configure a CLI measurement resource, and the victim UE can measure CLI on the CLI resource and feedback a measurement report to the network entity. The network entity can perform one or more interference mitigation actions in response to receiving the measurement report, such as power control or resource scheduling.

FIG. 5 illustrates a scenario in which UEs served by different cells experience CLI. As illustrated, UE 1 is served by Cell 1, UE 2 is served by Cell 2, and UE 1 is causing CLI to UE 2 (i.e., UE 1 is an aggressor UE, and UE 2 is a victim UE). in this example, when UE 2 discovers that it is experiencing interference (e.g., on downlink symbols that overlap with uplink symbols for UE 1), UE 2 can report the existence of interference to the network entity, and the network (e.g., Cell 2) can configure resources for UE 1 and measure CLI. Based on the signaling, UE 1 can transmit one or more signals, and UE 2 can measure CLI on the configured resources. The measurement may then be fed back to the network entity for the network to take one or more actions to mitigate CLI.

FIG. 6 illustrates another scenario in which UEs served by the same cell experience in CLI. As illustrated, UE 1 and UE 2 are served by Cell 1, UE 1 is transmitting on the uplink, and UE 2 is receiving on the downlink. Similarly to the scenario illustrated in FIG. 5, UE 2 may report to Cell 1 that it is experiencing interference, and Cell 1 can configure resources for measuring CLI. UE 2 may measure CLI on the configured resources and report the measurement back to Cell 1 for use in interference mitigation operations by Cell 1.

Generally, in typical CLI measurement scenarios, the victim UE need not know about the aggressor UE's actual TDD uplink/downlink configuration (e.g., slot format) or SRS transmission configuration. The victim UE may measure CLI based on a network CI resource configuration, and may not blindly detect CLI and measure CLI prior to receiving a CLI resource configuration. Additionally, CLI may be defined as a layer-3 measurement and reporting mechanism in which CLI measurement is based on radio resource control (RRC) configurations. If the UE indicates that it supports CLI measurement in a capability signaling report to the UE, and if the network configures a CLI measurement resource to be measured by the UE, the UE can start measurement until the network transmits a reconfiguration RRC message that disables CLI measurement.

Because typical CLI measurement scenarios involve the scheduling of the aggressor and victim UE, CLI measurement may impose a resource and signaling overhead between the aggressor UE, the victim UE, and the serving network entities. Further, dynamic TDD configuration may switch UL/DL configurations based on scheduling; that is, as TDD configurations switch, different UEs may become victim and aggressor UEs. A first UE that is an aggressor to a second UE in a first TDD configuration may become a victim to the second UE in a second TDD configuration. However, because of channel reciprocity, characteristics of interference between the first and second UEs may be similar regardless of whether the particular UE is an aggressor or a victim UE. Thus, a UE can estimate the interference it causes to other UEs based on its own interference measurements.

Aspects of the present disclosure may provide for rapid configuration of CLI measurement that leverages the properties of channel reciprocity to rapidly measure CLI and take one or more actions to mitigate CLI.

FIG. 7 illustrates example operations 700 that may be performed by a user equipment (UE) to measure cross link interference, according to aspects described herein. As illustrated, operations 700 may begin at 702 where the UE receives, from a network entity, configuration information identifying a cross link interference (CLI) resource.

At 704, the UE measures interference with respect to one or more other UEs on the identified CLI resource.

At 706, the UE transmits, to the network entity, a measurement report based on the measured interference.

FIG. 8 illustrates example operations 800 that may be performed by a network entity to configure a UE to measure cross link interference, according to aspects described herein. The operations illustrated in FIG. 8 may be complementary operations to those described in FIG. 7 above.

As illustrated, operations 800 may begin at 802, where a network entity transmits, to a user equipment (UE), configuration information identifying a cross link interference (CLI) resource.

At 804, the network entity receives, from the UE, a measurement report including one or more measurements of interference with respect to one or more UEs on the identified CLI resource.

At 806, the UE takes one or more actions to mitigate potential interference to the UE based on the received measurement report.

Generally, based on scheduling information for different UEs, a network entity can schedule a potential aggressor UE to perform a CLI measurement in the UE downlink reception and may configure the resource for reciprocal CLI measurement (leveraging, as discussed above, the reciprocal characteristics of channels between different wireless communication devices).

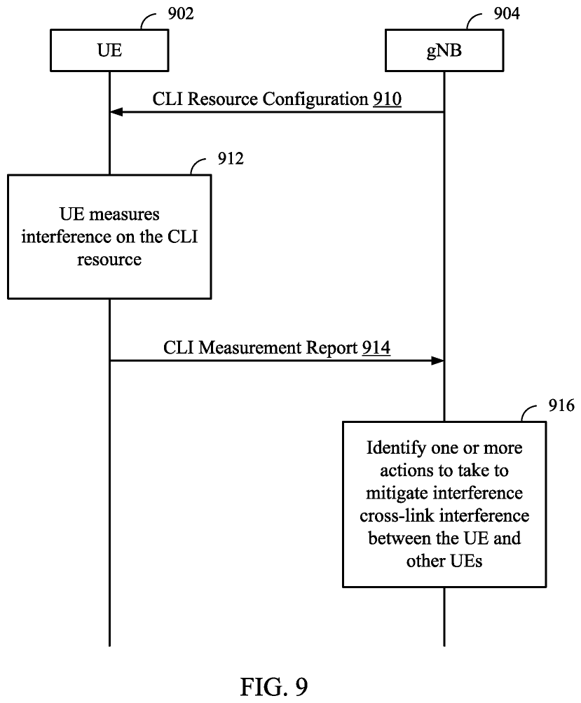

FIG. 9 illustrates a message flow diagram illustrating example messages that may be exchanged between a UE 902 and a network entity 904 to configure CLI measurement, according to aspects described herein. As illustrated, the network entity 904 can transmit a CLI resource configuration 910 to configure UE 902 to measure CLI. The resource may be configured as one or more downlink symbols scheduled in the UE's TDD configuration and can include an indication of reciprocity in the resource configuration. The UE measures interference at 912 and feeds back a measurement report 914, and the network entity can, at 916, determine the amount of interference between the potential aggressor UE and other UEs and/or take one or more actions to mitigate potential interference between the potential aggressor UE and other UEs.

As discussed, the CLI measurement techniques discussed herein need not be triggered by the detection of interference by a victim UE and the reporting of such interference. A reciprocal resource pattern can be scheduled to measure potential interference between a potential aggressor UE and other UEs. For example, a UE may estimate its uplink transmission to determine whether it has the potential to introduce interference to other UEs. Generally, a UE may be configured to measure resources with reciprocal characteristics.

In some aspects, the scheduling of CLI measurement may be based on a reciprocity pattern between TDD uplink/downlink symbol configurations for different UEs. The configuration may be based on a medium access control (MAC) control element (CE) or a downlink control information (DCI). In some aspects, based on the scheduling information, the network may be able to determine that particular slots take a reciprocal channel and interference may exist between the potential aggressor UE and other UEs in these slots. The network entity may configure a pattern to allow for the potential aggressor to perform a CLI measurement, and based on the measurement reported by the potential aggressor UE, the network entity may identify which UEs may be interfered with by the potential aggressor UE.

CLI measurements may be based on RSSI or RSRP. RSSI may allow for the measurement of a power level, with less computational overhead, of received signals, whether those signals are data signals or reference symbols. RSRP may be used to provide additional details of the interference based on sequence detection for a specified RS. In some aspects, the network entity may indicate whether the UE is to measure one or both of RSSI or RSRP in a reciprocal CLI measurement resource. In some aspects, the configuration may configure resources based on a slot index. The indication of reciprocal resources on which CLI is to be measured may include a slot index showing with slot(s) take a reciprocal characteristic, and for these slots, the configuration may include an indication of whether one or both of RSSI or RSRP are to be measured.

In some aspects, the configuration indication may include a list of resource indices. The list may specify the resources that take a reciprocal characteristic for measurement of CLI. For each resource, the list may indicate whether the UE is to be configured to measure RSSI, RSRP, or both RSSI and RSRP.

In some aspects, different resources may be configured differently. For example, whether no reference signal resource is specified for an uplink transmission, the UE may be configured to measure RSSI. However, where a reference signal resource is specified for an uplink transmission (e.g., from some UE served by the network entity), the UE may be configured to measure one or both of an RSSI or an RSRP.

### Example Embodiments

Embodiment 1: A method for wireless communications by a user equipment (UE), comprising receiving, from a network entity, configuration information identifying a cross link interference (CLI) resource, measuring interference with respect to one or more other UEs on the identified CLI resource, and transmitting, to the network entity, a measurement report based on the measured interference.

Embodiment 2: The method of Embodiment 1, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

Embodiment 3: The method of Embodiment 1 or 2, wherein the configuration information includes information identifying a resource pattern with reciprocal characteristics.

Embodiment 4: The method of any of Embodiments 1 to 3, wherein the configuration information is received in a medium access control (MAC) control element (CE) or in downlink control information (DCI).

Embodiment 5: The method of any of Embodiments 1 to 4, wherein the measured interference comprises one or both of a received signal strength indicator (RSSI) measurement or a reference signal received power (RSRP) measurement.

Embodiment 6: The method of Embodiment 5, wherein the configuration information includes information identifying whether the measurement report includes an RSSI measurement, an RSRP measurement, or both an RSSI and an RSRP measurement.

Embodiment 7: The method of any of Embodiments 1 to 6, wherein the identified CLI resource comprises one or more identified slots in which the UE is to measure interference.

Embodiment 8: The method of any of Embodiments 1 to 7, wherein the configuration information comprises a list of resource indices associated with the identified CLI resource in which the UE is to measure interference.

Embodiment 9: The method of any of Embodiments 1 to 8, wherein the configuration information includes an identification of a type of measurement to report for each of a plurality of resources on which an interference condition may exist between the UE and one or more other UEs.

Embodiment 10: A method for wireless communications by a network entity, comprising transmitting, to a user equipment (UE), configuration information identifying a cross link interference (CLI) resource, receiving, from the UE, a measurement report including one or more measurements of interference with respect to one or more other UEs on the identified CLI resource, and taking one or more actions to mitigate potential interference to the UE based on the received measurement report.

Embodiment 11: The method of Embodiment 10, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

Embodiment 12: The method of Embodiment 10 or 11, wherein the configuration information includes information identifying a resource pattern with reciprocal characteristics.

Embodiment 13: The method of any of Embodiments 10 to 12, wherein the configuration information is transmitted via a medium access control (MAC) control element (CE) or via downlink control information (DCI).

Embodiment 14: The method of any of Embodiments 10 to 13, wherein the measurement report comprises one or both of a received signal strength indicator (RSSI) measurement or a reference signal received power (RSRP) measurement for the CLI resource.

Embodiment 15: The method of Embodiment 14, wherein the configuration information includes information identifying whether the measurement report includes an RSSI measurement, an RSRP measurement, or both an RSSI and an RSRP measurement.

Embodiment 16: The method of any of Embodiments 10 to 15, wherein the identified CLI resource comprises one or more identified slots in which the UE is to measure interference based on a conflict between a type of traffic associated with the identified slots for the UE and a type of traffic associated with one or more other UEs.

Embodiment 17: The method of any of Embodiments 10 to 16, wherein the configuration information comprises a list of resource indices associated with the identified CLI resource in which the UE is to measure interference.

Embodiment 18: The method of any of Embodiments 10 to 17, wherein the configuration information includes an identification of a type of measurement to report for each of a plurality of resources on which an interference condition may exist between the UE and one or more other UEs.

Embodiment 19: An apparatus for wireless communications by a user equipment (UE), comprising a processor configured to receive, from a network entity, configuration information identifying a cross link interference (CLI) resource, measure interference with respect to one or more other UEs on the identified CLI resource, and transmit, to the network entity, a measurement report based on the measured interference, and a memory.

Embodiment 20: The apparatus of Embodiment 19, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

Embodiment 21: The apparatus of Embodiments 19 or 20, wherein the configuration information includes information identifying a resource pattern with reciprocal characteristics.

Embodiment 22: The apparatus of any of Embodiments 19 to 21, wherein the configuration information is received in a medium access control (MAC) control element (CE) or in downlink control information (DCI).

Embodiment 23: The apparatus of any of Embodiments 19 to 22, wherein the measured interference comprises one or both of a received signal strength indicator (RSSI) measurement or a reference signal received power (RSRP) measurement.

Embodiment 24: The apparatus of Embodiment 23, wherein the configuration information includes information identifying whether the measurement report includes an RSSI measurement, an RSRP measurement, or both an RSSI and an RSRP measurement.

Embodiment 25: The apparatus of any of Embodiments 19 to 24, wherein the identified CLI resource comprises one or more identified slots in which the UE is to measure interference.

Embodiment 26: The apparatus of any of Embodiments 19 to 25, wherein the configuration information comprises a list of resource indices associated with the identified CLI resource in which the UE is to measure interference.

Embodiment 27: The apparatus of any of Embodiments 19 to 26, wherein the configuration information includes an identification of a type of measurement to report for each of a plurality of resources on which an interference condition may exist between the UE and one or more other UEs.

Embodiment 28: An apparatus for wireless communications by a network entity, comprising a processor configured to transmit, to a user equipment (UE), configuration information identifying a cross link interference (CLI) resource, receive, from the UE, a measurement report including one or more measurements of interference with respect to one or more other UEs on the identified CLI resource, and take one or more actions to mitigate potential interference to the UE based on the received measurement report, and a memory.

Embodiment 29: The apparatus of Embodiment 28, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

Embodiment 30: The apparatus of Embodiments 28 or 29, wherein the configuration information includes information identifying a resource pattern with reciprocal characteristics.

Embodiment 31: The apparatus of any of Embodiments 28 to 30, wherein the configuration information is transmitted via a medium access control (MAC) control element (CE) or via downlink control information (DCI).

Embodiment 32: The apparatus of any of Embodiments 28 to 31, wherein the measurement report comprises one or both of a received signal strength indicator (RSSI) measurement or a reference signal received power (RSRP) measurement for the CLI resource.

Embodiment 33: The apparatus of Embodiment 32, wherein the configuration information includes information identifying whether the measurement report includes an RSSI measurement, an RSRP measurement, or both an RSSI and an RSRP measurement.

Embodiment 34: The apparatus of any of Embodiments 28 to 33, wherein the identified CLI resource comprises one or more identified slots in which the UE is to measure interference based on a conflict between a type of traffic associated with the identified slots for the UE and a type of traffic associated with one or more other UEs.

Embodiment 35: The apparatus of any of Embodiments 28 to 34, wherein the configuration information comprises a list of resource indices associated with the identified CLI resource in which the UE is to measure interference.

Embodiment 36: The apparatus of any of Embodiments 28 to 35, wherein the configuration information includes an identification of a type of measurement to report for each of a plurality of resources on which an interference condition may exist between the UE and one or more other UEs.

Embodiment 37: An apparatus for wireless communications by a user equipment (UE), comprising means for receiving, from a network entity, configuration information identifying a cross link interference (CLI) resource, means for measuring interference with respect to one or more other UEs on the identified CLI resource, and means for transmitting, to the network entity, a measurement report based on the measured interference.

Embodiment 38: The apparatus of Embodiment 37, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

Embodiment 39: The apparatus of Embodiments 36 or 37, wherein the configuration information includes information identifying a resource pattern with reciprocal characteristics.

Embodiment 40: The apparatus of any of Embodiments 36 to 39, wherein the configuration information is received in a medium access control (MAC) control element (CE) or in downlink control information (DCI).

Embodiment 41: The apparatus of any of Embodiments 36 to 40, wherein the measured interference comprises one or both of a received signal strength indicator (RSSI) measurement or a reference signal received power (RSRP) measurement.

Embodiment 42: The apparatus of Embodiment 41, wherein the configuration information includes information identifying whether the measurement report includes an RSSI measurement, an RSRP measurement, or both an RSSI and an RSRP measurement.

Embodiment 43: The apparatus of any of Embodiments 36 to 42, wherein the identified CLI resource comprises one or more identified slots in which the UE is to measure interference.

Embodiment 44: The apparatus of any of Embodiments 36 to 43, wherein the configuration information comprises a list of resource indices associated with the identified CLI resource in which the UE is to measure interference.

Embodiment 45: The apparatus of any of Embodiments 36 to 44, wherein the configuration information includes an identification of a type of measurement to report for each of a plurality of resources on which an interference condition may exist between the UE and one or more other UEs.

Embodiment 46: An apparatus for wireless communications by a network entity, comprising means for transmitting, to a user equipment (UE), configuration information identifying a cross link interference (CLI) resource, means for receiving, from the UE, a measurement report including one or more measurements of interference with respect to one or more other UEs on the identified CLI resource, and means for taking one or more actions to mitigate potential interference to the UE based on the received measurement report.

Embodiment 47: The apparatus of Embodiment 46, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

Embodiment 48: The apparatus of Embodiment 46 or 47, wherein the configuration information includes information identifying a resource pattern with reciprocal characteristics.

Embodiment 49: The apparatus of any of Embodiments 46 to 48, wherein the configuration information is transmitted via a medium access control (MAC) control element (CE) or via downlink control information (DCI).

Embodiment 50: The apparatus of any of Embodiments 46 to 49, wherein the measurement report comprises one or both of a received signal strength indicator (RSSI) measurement or a reference signal received power (RSRP) measurement for the CLI resource.

Embodiment 51: The apparatus of Embodiment 50, wherein the configuration information includes information identifying whether the measurement report includes an RSSI measurement, an RSRP measurement, or both an RSSI and an RSRP measurement.

Embodiment 52: The apparatus of any of Embodiments 46 to 51, wherein the identified CLI resource comprises one or more identified slots in which the UE is to measure interference based on a conflict between a type of traffic associated with the identified slots for the UE and a type of traffic associated with one or more other UEs.

Embodiment 53: The apparatus of any of Embodiments 46 to 52, wherein the configuration information comprises a list of resource indices associated with the identified CLI resource in which the UE is to measure interference.

Embodiment 54: The apparatus of any of Embodiments 46 to 53, wherein the configuration information includes an identification of a type of measurement to report for each of a plurality of resources on which an interference condition may exist between the UE and one or more other UEs.

### Additional Considerations

The techniques described herein may be used for various wireless communication technologies, such as NR (for example, 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, or 5G wireless technologies, aspects of the present disclosure can be applied in other generation-based communication systems.

In 3GPP, the term “cell” can refer to a coverage area of a Node B (NB) or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, or other types of cells. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having an association with the femto cell (for example, UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (for example, a smart ring, a smart bracelet, etc.), an entertainment device (for example, a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, which may be narrowband IoT (NB-IoT) devices.

Some wireless networks (for example, LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (for example, 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (for example, 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (for example, a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (for example, one or more other UEs), and the other UEs may utilize the resources scheduled by the UE for wireless communication. In some examples, a UE may function as a scheduling entity in a peer-to-peer (P2P) network, or in a mesh network. In a mesh network example, UEs may communicate directly with one another in addition to communicating with a scheduling entity.

As used herein, the term “determining” may encompass one or more of a wide variety of actions. For example, “determining” may include calculating, computing, processing, deriving, investigating, looking up (for example, looking up in a table, a database or another data structure), assuming and the like. Also, “determining” may include receiving (for example, receiving information), accessing (for example, accessing data in a memory) and the like. Also, “determining” may include resolving, selecting, choosing, establishing and the like.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communications by a user equipment (UE), comprising:
receiving, from a network entity, configuration information identifying a cross link interference (CLI) resource;
measuring interference with respect to one or more other UEs on the identified CLI resource; and
transmitting, to the network entity, a measurement report based on the measured interference.

2. The method of claim 1, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

3. The method of claim 1, wherein the configuration information includes information identifying a resource pattern with reciprocal characteristics.

4. The method of claim 1, wherein the configuration information is received in a medium access control (MAC) control element (CE) or in downlink control information (DCI).

5. The method of claim 1, wherein the measured interference comprises one or both of a received signal strength indicator (RSSI) measurement or a reference signal received power (RSRP) measurement.

6. The method of claim 5, wherein the configuration information includes information identifying whether the measurement report includes an RSSI measurement, an RSRP measurement, or both an RSSI and an RSRP measurement.

7. The method of claim 1, wherein the identified CLI resource comprises one or more identified slots in which the UE is to measure interference.

8. The method of claim 1, wherein the configuration information comprises a list of resource indices associated with the identified CLI resource in which the UE is to measure interference.

9. The method of claim 1, wherein the configuration information includes an identification of a type of measurement to report for each of a plurality of resources on which an interference condition may exist between the UE and one or more other UEs.

10. A method for wireless communications by a network entity, comprising:
transmitting, to a user equipment (UE), configuration information identifying a cross link interference (CLI) resource;
receiving, from the UE, a measurement report including one or more measurements of interference with respect to one or more other UEs on the identified CLI resource; and
taking one or more actions to mitigate potential interference to the UE based on the received measurement report.

11. The method of claim 10, wherein the configuration information is based on a reciprocity pattern associated with one of scheduled uplink slots for the UE conflicting with scheduled downlink slots for the one or more other UEs or scheduled downlink slots for the UE conflicting with scheduled uplink slots for the one or more other UEs.

12. The method of claim 10, wherein the configuration information includes information identifying a resource pattern with reciprocal characteristics.

13. The method of claim 10, wherein the configuration information is transmitted via a medium access control (MAC) control element (CE) or via downlink control information (DCI).

14. The method of claim 10, wherein the measurement report comprises one or both of a received signal strength indicator (RSSI) measurement or a reference signal received power (RSRP) measurement for the CLI resource.

15. The method of claim 14, wherein the configuration information includes information identifying whether the measurement report includes an RSSI measurement, an RSRP measurement, or both an RSSI and an RSRP measurement.

16. The method of claim 10, wherein the identified CLI resource comprises one or more identified slots in which the UE is to measure interference based on a conflict between a type of traffic associated with the identified slots for the UE and a type of traffic associated with one or more other UEs.

17. The method of claim 10, wherein the configuration information comprises a list of resource indices associated with the identified CLI resource in which the UE is to measure interference.

18. The method of claim 10, wherein the configuration information includes an identification of a type of measurement to report for each of a plurality of resources on which an interference condition may exist between the UE and one or more other UEs.

19. An apparatus for wireless communications by a user equipment (UE), comprising:
a processor configured to:
receive, from a network entity, configuration information identifying a cross link interference (CLI) resource;
measure interference with respect to one or more other UEs on the identified CLI resource; and
transmit, to the network entity, a measurement report based on the measured interference; and
a memory.

20. An apparatus for wireless communications by a network entity, comprising:
a processor configured to:
transmit, to a user equipment (UE), configuration information identifying a cross link interference (CLI) resource;
receive, from the UE, a measurement report including one or more measurements of interference with respect to one or more other UEs on the identified CLI resource; and
take one or more actions to mitigate potential interference to the UE based on the received measurement report; and
a memory.

21. An apparatus for wireless communications by a user equipment (UE), comprising:
means for receiving, from a network entity, configuration information identifying a cross link interference (CLI) resource;
means for measuring interference with respect to one or more other UEs on the identified CLI resource; and
means for transmitting, to the network entity, a measurement report based on the measured interference.

22. An apparatus for wireless communications by a network entity, comprising:
means for transmitting, to a user equipment (UE), configuration information identifying a cross link interference (CLI) resource;
means for receiving, from the UE, a measurement report including one or more measurements of interference with respect to one or more other UEs on the identified CLI resource; and
means for taking one or more actions to mitigate potential interference to the UE based on the received measurement report.
